(19) United States
(12) Patent Application Publication
(10) Pub. No.: US 2015/0027818 A1
(43) Pub. Date: Jan. 29, 2015

(54) DEVICE FOR SECURING A GOODS TRANSPORTATION VEHICLE TO A DOCK AND INSTALLATION COMPRISING SAID DEVICE

(71) Applicant: A.S.A. FERMETURES, Lescar (FR)

(72) Inventor: Ignace Bellota, Laroin (FR)

(73) Assignee: A.S.A. FERMETURES, Lescar (FR)

(21) Appl. No.: 14/384,805

(22) PCT Filed: Mar. 15, 2013
(86) PCT No.: PCT/FR2013/050550

§ 371 Date: Sep. 12, 2014

(30) Foreign Application Priority Data
Mar. 15, 2012 (FR) 1200797

(51) Int. Cl. B60T 3/00; B60T 1/04

(52) U.S. Cl. CPC B60T 3/00; B60T 1/04
USPC 188/32

(57) ABSTRACT

The manual securing device includes a frame (1) supporting a guide rail (2), on which is mounted slidably a support head (3) receiving a chock (4) that can occupy a retracted position and a locked position away from the retracted position. This device is characterized in that the rail (2) has a series of holes (20) the head has a guide sheath (30) slidably engaged on the guide rail (2), the sheath (30) has at least one radial through-hole (31) designed to line up axially with one of the holes (20) of the guide rail (2) by sliding the head (3), and the head (3) has at least one locking pin (32) designed to be engaged in the alignment of holes (20, 31) formed, so that it can be immobilized in translation along the guide rail (2).

### TECHNICAL FIELD

The present invention falls within the field of equipment used to immobilize goods transportation vehicles against a transfer dock, and it relates more particularly to a manually operable device for securing to a dock.

### PRIOR STATE OF THE ART

It is know that goods transportation vehicles, with a view to the transfer of goods, must be immobilized against the transfer dock by devices external to the vehicle. Typically, these devices are installed fasteningly, in front of the dock, either on the vehicle's parking area or lateral to this. They normally comprise a frame designed to be securely fixed to the ground and one or more chocks installed on the frame and able to occupy a retracted position and a position locking the wheel or wheels of the vehicle. Depending on this position, the or each chock is placed in front of and in contact with the corresponding wheel of the vehicle so as to prevent any forward movement of the latter.

A manual device for securing a goods transportation vehicle to a dock is known from patent application US 2009/0194375. This device comprises a body in the form of a rectilinear guide rail on which is installed a sliding head bearing a chock for locking one of the wheels of the vehicle. This chock is mounted on the head in a transversally movable way between a locked position and a retracted position.

The guide rail bears a rack and the sliding head bears, in an articulated manner, a blocking and actuating arm equipped with a locking pin, brought by pivoting the arm, between two teeth of the rack to ensure the locking in translation of the head along the rail. The blocking and actuating arm is equipped away from the head with a guide slot in which is mounted a slide fixed to a horizontal guide engaged slidably in a guide hole formed in a vertical side carried by the head, the chock being carried by this horizontal guide.

The chock is formed by a vertical side carried by the horizontal guide and by a second, lower, horizontal guide.

This device is dependent on the ground being perfectly flat. In effect, the pressure that can be exercised by the wheel is transferred to the chock, which then presses on the ground. However, for most parking areas associated with transfer docks, the two areas where the wheels of vehicles pass are, as a result in particular of the weight of these vehicles, heavily deformed, and very rarely in good condition. This is accentuated by the fact that, when the vehicles are driven to the dock, their wheels are in almost the same parts of the parking area, which contributes significantly to sagging in these parking areas.

In addition, the chock of the device according to patent application US 2009/0194375 is sized to extend well above the axle of the vehicle's wheel so that the resultant of the forces that the wheel applies on it is horizontal. However, this arrangement has the disadvantage of being unable to position this chock behind the vehicle's wheel when the latter is associated with a flap or a wheel guard. Yet such special features, present on a majority of vehicles, prevent the chock being put in place.

Pressing by the wheel on the chock is realized on the section of the latter, which poses a problem. During the unloading of the vehicle, the wheel exerts a pressure of several tens of decanewtons on the section of the chock. In many chocking situations, the pressure is so great that removing the chock is complicated, and sometime requires the driver to remove the wheel to be able to disengage it. However, the pressure will be applied on a very reduced surface area, which will lead to the chock being embedded in one of the grooves of the tire's tread surface. It will therefore be impossible to remove the chock after the vehicle has been unloaded, essentially because disengagement is accomplished by traction parallel to the wheel. This patent application also describes a variant of the securing device. For installing it in the chocking position, the chock according to this second embodiment variant is first raised, then brought above the locking rack and then brought to engage with this rack by a downward movement.

According to this arrangement, the wheels of the vehicle are necessarily circulating over the rack, which, in particular at the inter-tooth spaces, therefore fills with mud, gravel and other elements carried by the grooves of the vehicle's tread surfaces. However, this filling of the inter-tooth spaces prevents the chock being locked in position, or at least leads to poor locking, and can be the cause of an accidental unlocking as a result of the forces exercised by the wheel. As is understood, such a situation compromises safety and must be avoided.

In the case where the height of the chock is less than the wheel axle's height above the ground, the vehicle's unloading or its slight backward movement can make it impossible to remove the chock from the rack. This is due to the fact that this chock can only be disengaged from the rack by an upward movement and it is locked on the rack by the curvature of the wheel. In addition, the offset of the chock's support rails accentuates the locking effect.

In the case where the height of the chock is greater than the wheel axle's height above the ground, its use for vehicles with wheel guards or flaps proves impossible. Secondly, the forces produced by the wheel during an accidental start (approximately 10,000 decanewtons) will have a tendency to tilt the chock, which requires a substantial bearing base and a transfer of the tilting forces.

Finally, using such a chock assumes precise positioning of the vehicle, which is difficult to achieve in practice.

### DESCRIPTION OF THE INVENTION

The present invention aims to improve the reliability of manual securing devices.

To this end, the manual securing device according to the invention, comprising a frame forming a surface bearing on the ground, supporting above and away from this surface a horizontal rectilinear guide rail, on which is mounted slidably a support head receiving a chock that can occupy a retracted position and a locked position away from the retracted position, is essentially characterized in that:
the guide rail has a series of vertical cylindrical holes regularly spaced along the horizontal sliding axis of the head;
said head has a guide sheath slidably engaged on the guide rail;
said sheath has at least one radial through-hole designed to line up axially with one of the holes of the guide rail by sliding the head; and
the head has at least one movable locking pin designed to be engaged in the alignment of holes formed, so that it can be immobilized in translation along the guide rail.

According to another characteristic of the invention, the chock's height above the ground is less than the height of the wheel axle of transport vehicles.

According to another characteristic of the invention, the locking pin is carried by an actuating lever articulated to the support head above the guide rail, the distance between the locking pin and the lever's articulation axis being shorter than the distance between this locking pin and the free extremity of the lever, said lever being movable between an unlocked position, according to which the locking pin is disengaged from the guide rail's holes, and a locking position, according to which said locking pin is positioned in a hole of the sheath and in a hole of the rail.

According to another characteristic of the invention, the head has two locking pins and the guide sheath has two through-holes, separated from each other, designed to receive the two locking pins.

According to another characteristic of the invention, the chock is formed of a horizontal rigid rod, slidably engaged in a second sheath borne by the head above the first sheath, the chock and this second sheath extending in a transverse direction with respect to that of the guide rail and said chock being able to take a retracted position, according to which it extends from one side of the guide rail, and a locked position, according to which it extends, by an active portion, from the other side of the guide rail, said active portion being designed to come into contact with the tread surface of the corresponding wheel of the vehicle to be immobilized.

According to another characteristic of the invention, the chock is cylindrical.

According to another characteristic of the invention, the horizontal rail has a circular straight cross-section and the head is equipped with means of immobilization in rotation, these means being separate from the guide rail.

Such an arrangement prevents the torsional forces being transmitted to the guide rail.

According to another characteristic of the invention, the means of immobilizing the head in rotation comprise a brace fixed to the head away from the longitudinal geometrical axis of the first sheath, and a slider plate fixed to the frame, extending parallel to the guide rail, on which the brace bears slidably by its lower extremity.

According to another characteristic of the invention, the means of immobilization in rotation comprises, in addition, a first elongated stop fixed to the frame and extending parallel to the guide rail, and a second cooperating stop, fixed to the first sheath, this second stop bearing slidably against the first stop.

According to another characteristic of the invention, the device has a means of detecting the locked position of the chock and the locking position of the lever.

According to another characteristic of the invention, the detection means consist of a first detection element fixed to a handle that the chock possesses, and a second detection element fixed to the actuating lever, the two detection elements coming opposite each other when the chock is in the locked position and the or each locking pin is in the locking position in the corresponding hole(s) of the guide rail.

The present invention also relates to a loading dock installation comprising at least one securing device according to the invention.

### BENEFITS OF THE INVENTION

The securing device according to the invention presents the following benefits:
its proper operation does not depend on the degree of deformation of the parking area, nor on the state of cleanliness of the vehicle's tires or the environment,
the cylindrical shape of the chock allows a uniform bearing on the tire;
the pushing force exercised by the wheel on the chock reinforces the locking of the pins in the guide rail. Their release poses no problem because of the multiplier effect created by the actuating lever. The unlocking of the pins leads to all of the wheel's pressure on the chock being released and the latter can therefore be freely actuated to its retracted position;
the chock, being located lower than the axle of the wheel, is always located below the wheel guard and its small size allows it to be housed between the flap and the wheel;
the backward tilting force induced on the chock by the wheel is transferred by the brace and transmitted to the slider plate;
the very long travel of the chock makes it possible to handle, for immobilization, a vehicle more than 20 centimeters away from the chocking device, and is therefore effective even the case of very offset vehicles.

### SUMMARY DESCRIPTION OF THE FIGURES AND DRAWINGS

Other advantages, aims and characteristics of the invention will become clear on reading the description of a preferred form of embodiment, given as a non-limiting example with reference to the drawings included in an appendix, in which:

FIGS. 1 and 2 are perspective views of a device according to the invention, the chock being in the retracted position and the head being unlocked;

FIG. 3 is a perspective view of the device according to the invention, the locking chock being in the locked position and the head being locked on the guide rail;

FIG. 4 shows a bottom view of the device according to the invention;

FIGS. 5 and 6 are perspective views of a device according to a second form of embodiment of the invention, the chock being in the locked position;

FIG. 7a is a side view of the device according to the second form of embodiment;

FIG. 7 is a cross-section view of the device along line AA of FIG. 7a;

FIG. 8 is a perspective view of the device according to the second form of embodiment, the chock being in the retracted position.

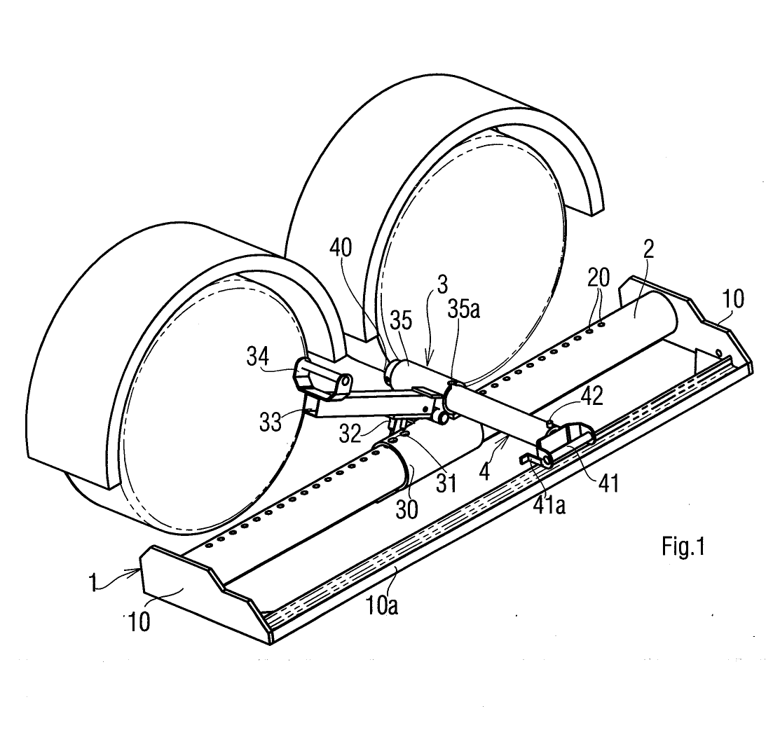

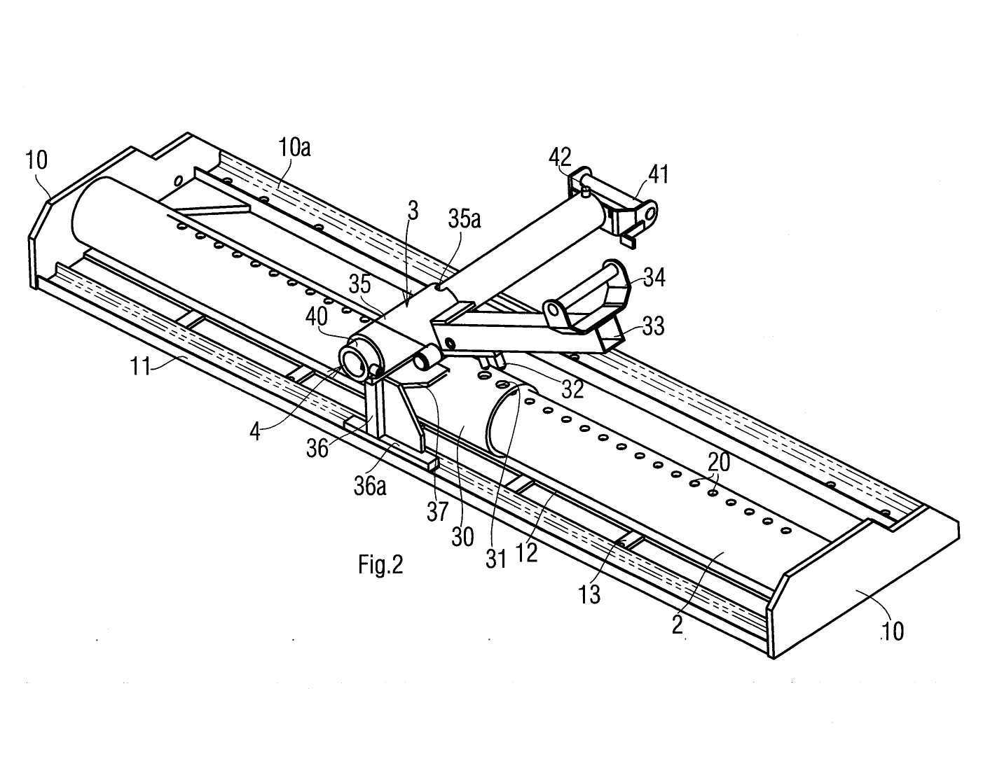

### BEST WAY OF REALIZING THE INVENTION

As shown, the device according to the invention for securing a goods transportation vehicle is designed to be anchored to the ground in front of the dock and lateral to the parking area of the vehicle opposite this dock.

This device comprises a frame 1 defining a surface bearing on the ground, supporting above and away from this surface a horizontal rectilinear guide rail 2, on which is mounted slidably a support head 3 receiving a chock 4 that can alternatively occupy a retracted position and a locked position away from the retracted position, according to which the chock 4, by an active portion 40 that it presents, is located above the vehicle's parking area and, by sliding the head 3 on the rail 2, can be brought against the tread surface of the vehicle's corresponding wheel, with a view to immobilizing the latter against the dock.

The frame 1, designed to be fixed to the ground by anchoring screws, is formed of two parallel vertical metal sides 10, distant from each other, each comprising a lower horizontal ground contact surface. The lower surface of one of the vertical sides 10 and the lower surface of the other side are coplanar and define a geometrical plane bearing on the ground. These two sides are joined to each other by a metal spacer 10a designed to rest on the ground. This spacer is formed by a profiled section with a U-shaped straight cross-section. It has through-holes designed to receive screws for anchoring to the ground.

Above and away from this surface, the frame 1, as defined, receives the guide rail 2. This guide rail, metallic, is fixed by its extremities to the two vertical sides 10, preferably by welding.

In the upper portion, the rail 2 has a series of vertical cylindrical holes 20. These holes are regularly spaced along a geometrical axis parallel to the longitudinal axis of the rail 2. In the actual form of embodiment, the guide rail 2 is formed of a commercially available tubular profiled section with a circular straight cross-section. The holes 20 are formed in the rail 20 so as to go right through the thickness of the tubular wall of the rail 2.

The head 3 is equipped with a metal guide sheath 30, having a cylindrical through-hole, via which it is engaged slidably on the guide rail 2.

The guide sheath 30, with regard to the line of holes 20 formed in the guide rail, has at least one through-hole 31 which, by sliding the head 3 on the rail 2, is brought opposite a hole 20 of the rail. In combination with this characteristic, the head is equipped with at least one movable metal locking pin 32. This pin is designed to be engaged in the alignment of holes 20, 31 formed, with a view to immobilizing the head 3 in translation along the rail 2.

In the preferred form of embodiment, the locking pin 32 is carried by an actuating lever 33 articulated to the head, above the guide rail 2. The lever 33 is articulated to the head along a horizontal axis perpendicular to the longitudinal axis of the guide rail 2. In order to facilitate its pivoting operation, the lever has an operating handle 34 at its free extremity. The locking pin 32 forms a protrusion under the lever 33.

To obtain an effect multiplying the force to be exercised on the handle 34 of the lever 33 with a view to disengage the locking pins from the corresponding holes of the rail, the distance between the levers articulation axis and the or each locking pin 32 is shorter than the distance between the or each pin 32 and the handle 34, and preferably by a ratio of 10.

Preferably, the head 3 has two locking pins 32 borne by the lever 33. According to this form of embodiment, the guide sheath 30 has two through-holes 31, separated from each other, designed to receive the two locking pins 32. The value of the center-to-center distance between these two holes will be equal to the value of the center-to-center distance between two consecutive holes 20 of the guide rail 2.

By pivoting the locking lever 33 downwards, the or each locking pin 32 is engaged in the corresponding alignment of holes in order to immobilize the head 3 in translation along the rail 2 in a position corresponding to the bearing of the active portion 40 of the chock 4 against the tread surface of the wheel of the vehicle to be immobilized. By pivoting the lever 33 upwards, the or each locking pin 32 is disengaged from the corresponding alignment of holes 20, 31, and the head 3, thus freed, can freely slide along the rail 2.

The chock 4 is formed of a rigid metal rod with a circular straight cross-section. This chock 4 is horizontal and is slidably engaged in a second metal sheath 35 borne by the head 3 above the first sheath 30. As can be seen, the chock 4 and the second sheath 35 by its longitudinal axis, extends in a transverse direction with respect to that of the guide rail 2 and more specifically in a perpendicular direction.

This second sheath 35 is fixed, for example by welding, to the first sheath. This second sheath has a cylindrical through-hole, in which the chock is engaged slidably.

The chock 4 by sliding in the second sheath 35 can be positioned either in a retracted position, according to which it extends from one side of the guide rail 2, or in a locked position, according to which it extends, by its active portion 40, from the other side of the guide rail 2 and, as said previously, above the vehicle's parking area.

In order to facilitate its operation, between the retracted position and the active position and vice-versa, the chock 4, along its extremity opposite the active portion 40, has an operating handle 41.

In the deployed position, the active portion 40 of the chock 4 opposes any forward movement of the vehicle, namely to any movement aimed at moving the rear of the vehicle away from the transfer dock. On the movement of the sheath 35, it is therefore likely to receive a radial, oblique pushing force directed both downwards and forward, of a nature to cause the sheath 30 and the chock 4 to be pivoted. However, to fulfill its function the chock 4 needs to remain in a horizontal position in the presence of such a pushing force. For this reason, the head 3 is equipped with a means of immobilization in rotation around the guide rail 2, this means being separate from said rail so that no torque is transmitted to the latter.

According to an actual form of embodiment, the means of immobilizing the head in rotation comprises a brace 36 fixed to the head 3 away from the longitudinal geometrical axis of the sheath 30, and a slider plate 11 fixed to the frame 1, on which the brace bears slidably by its lower extremity. As can be seen, this slider plate 11 is fixed by its extremities to the two vertical sides 10 of the frame. This slider plate 11 is designed to rest on the ground and to this end has, according to the bearing surface described earlier, a horizontal flat surface. This plate 11 extends parallel to the guide rail 2 from the side of the rail receiving the active portion 40 of the chock 4 when the chock is in the locked position.

According to the actual form of embodiment, the brace 36 is fixed, for example by welding, by its upper extremity to the sheath 35. In addition, this brace 36 is fixed by means of one or more reinforcing elements 37 to the sheath 30. On the lower extremity, the brace 36 is a slide-shaped element 36a bearing slidably on the slider plate 11.

Still according to the actual form of embodiment, the slider plate 11 is formed of a commercially available metal profiled section with a U-shaped straight cross-section. This profiled section is positioned such that its two lateral wings are vertical and turned upwards. The slide-shaped element 36a is positioned in the housing that defines the plate 11, bearing on the intrados surface of the latter's basal wing.

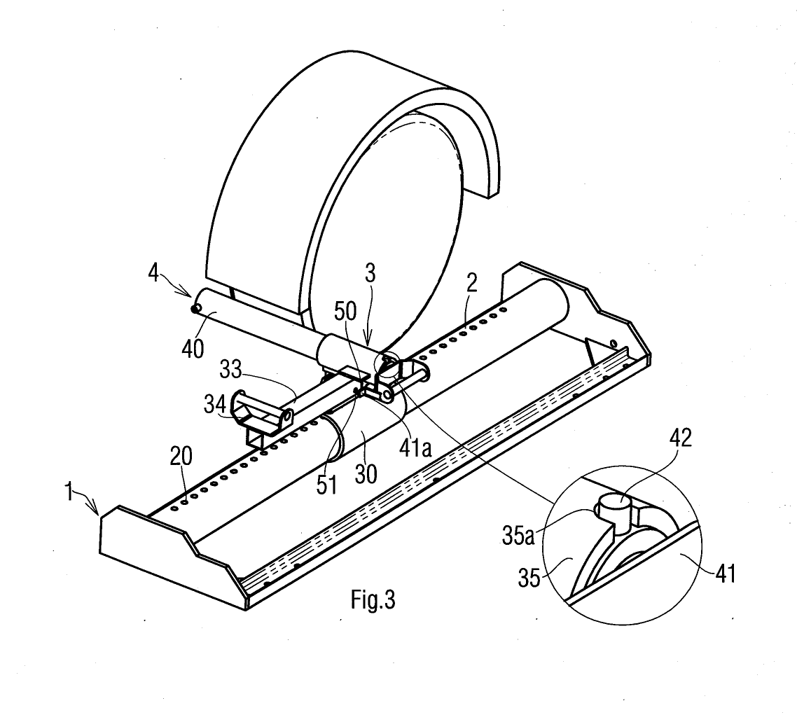

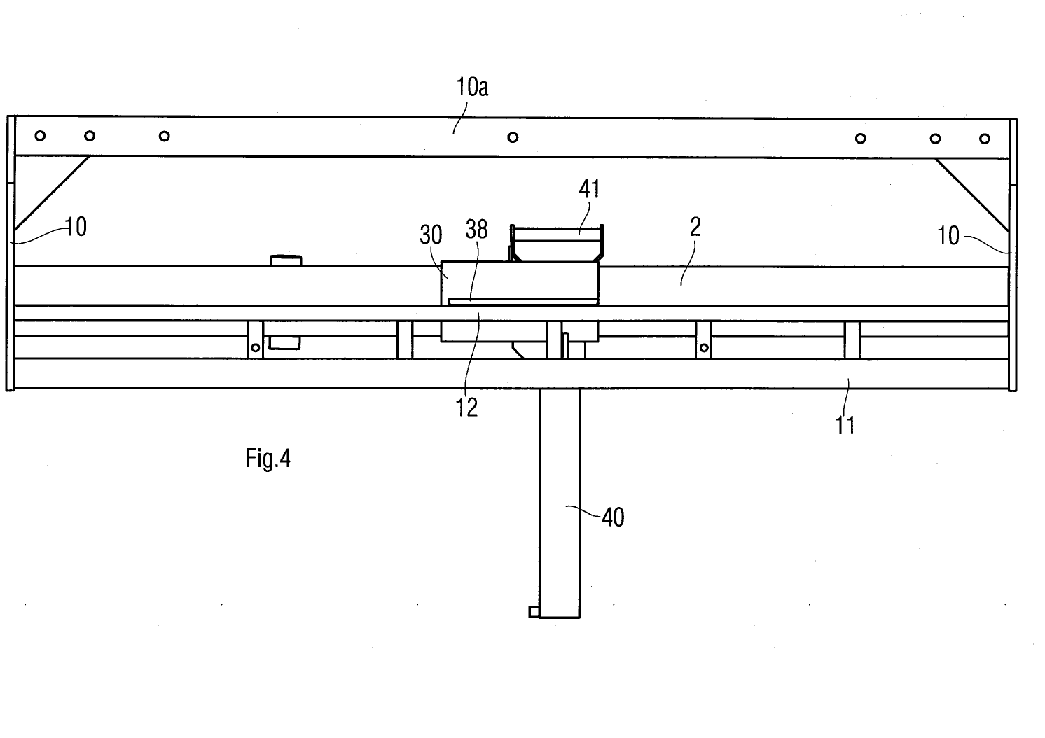

In considering FIG. 3, the arrangements as described oppose the tilting of the head counter-clockwise. To oppose the tilting of the head 3 in the opposite direction, a second means of immobilization in rotation is provided. This second means comprises a first elongated stop 12 parallel to the guide rail 2, fixed to the frame 1 and, more specifically, to the sides 10 of the latter, and a second cooperating stop 38, fixed to the first sheath 30, this second stop 38 bearing slidably against the first stop 12. This second means is also separate from the guide rail 2. In a variant, the second stop 38 consists of at least one roller fixed to the head 3 and more specifically to the sheath 30.

The first stop 12 is formed by a metal profiled section with a rectangular straight cross-section. This first stop is fixed, for example by welding, by its extremities to the sides 10 of the frame. This first stop is fixed to the plate 11 by regularly spaced reinforcing elements 13.

The second stop 38, metallic, is fixed, for example by welding, to the sheath 30 and forms a radial protrusion on the outer surface of the latter.

Advantageously the device has a means of detecting the locked position of the chock and the locking position of the locking pins and of the actuating lever. According to an actual form of embodiment, this means consists of a first detection element 50 fixed to the handle 41, and more specifically to a tab 41 a borne by the latter, and a second detection element 51 fixed to the lever 33. These detection elements, known per se, will be inductive type elements.

Detection of the locked position of the chock 4, and the direction of the locking position of the pins, requires, firstly, for the lever 33 to be in the locking position and, secondly, for the chock and the handle 41 to be in a predetermined angular position, otherwise the detection elements will be angularly offset from each other and will be unable to provide information concerning a correct unlocking condition. Thus, the chock 4 and the sheath 30 have an indexing means consisting of a spur 42 forming a radial protrusion on the cylindrical surface of the chock 4 and a notch 35a made in the extremity of the sheath 30, designed to receive the spur 42 when the chock is in the locked position. Thus, the locked position is also evidenced by the penetration of the spur 42 into the notch 35a. The locking position of the lever 33 can only be detected when the detection element borne by the latter is opposite the detection element borne by the tab 41a of the handle. It should be noted that, as the articulation axis of the lever, the longitudinal axis of the second sheath and of the chock 41 are not one and the same, only the locked position of the chock, evidenced by the engagement of the spur 42 in the notch 35a, and the locking position of the lever 33 fulfill the condition of the alignment of the two detection elements.

This detection means is able, when the chock 4 is in the locked position and the pins 32 are in the locking position in the holes 20 and 31, to send an authorization signal allowing the doors of the transfer dock to be opened and ordering the activation of the signal lights.

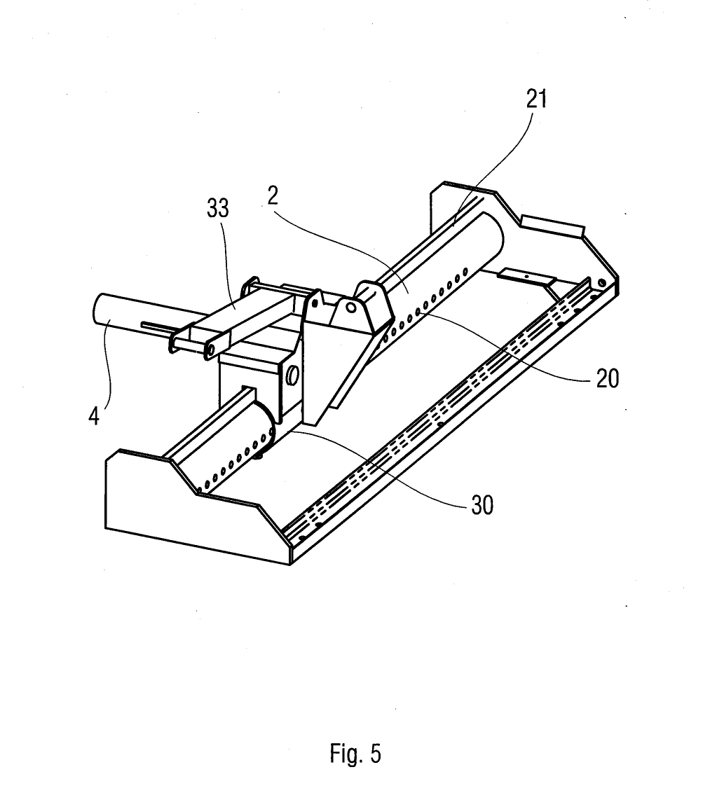

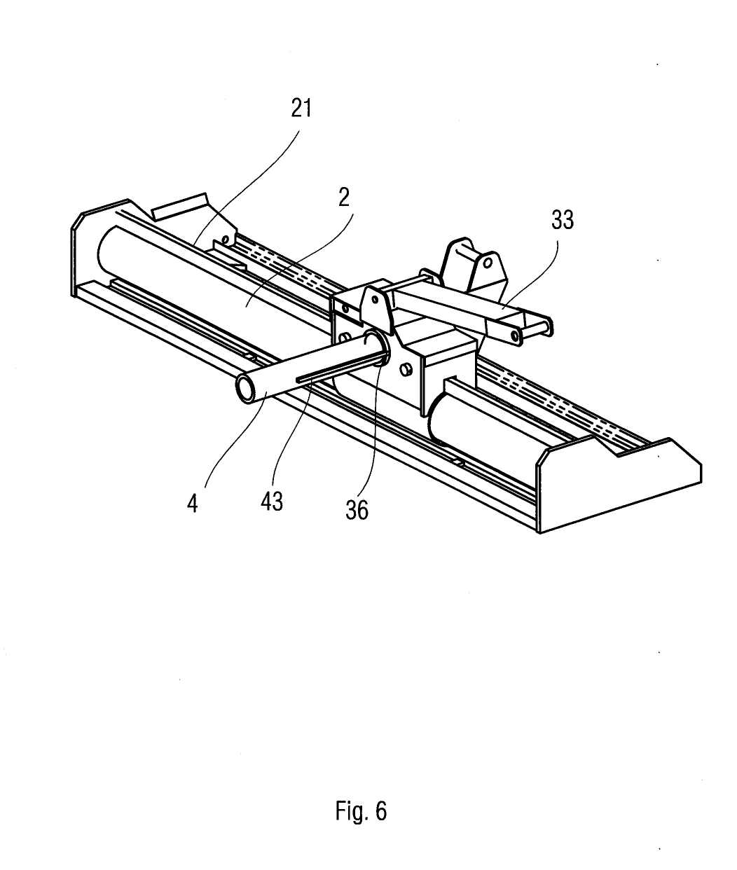

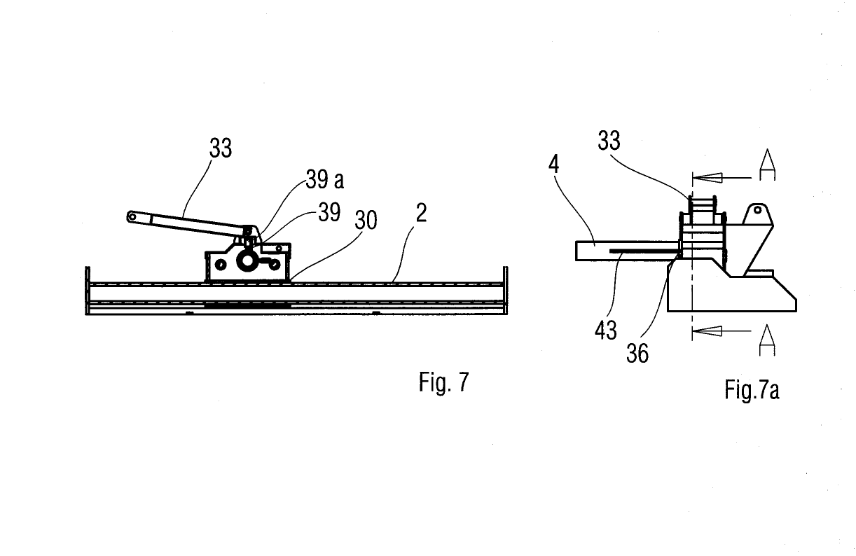

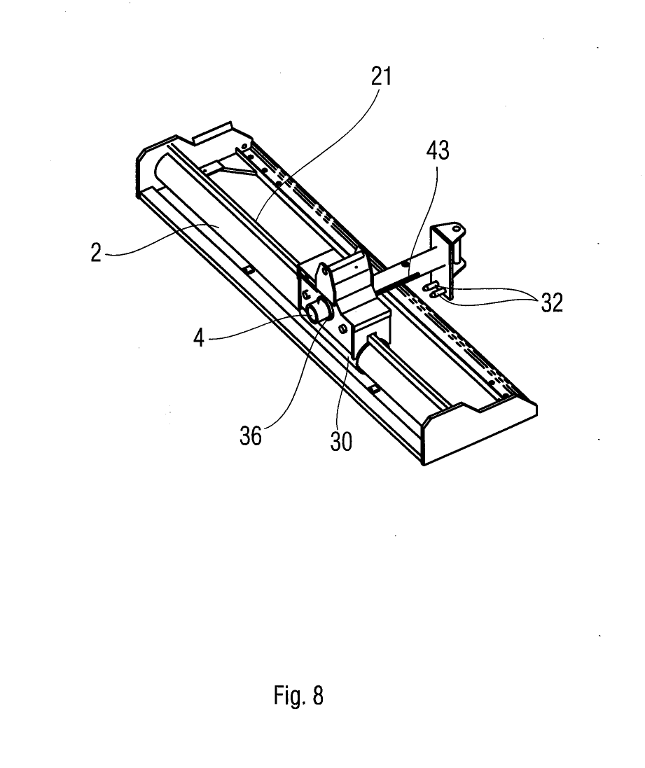

FIGS. 5 to 8 show a manual securing device according to an execution variant. According to this variant, the locking pin or each locking pin 32 is no longer borne by a lever 33 but by the chock 4 itself. In this configuration, the holes 20 of the rail 2 and of the sheath 30 designed to receive the or each locking pin 32, are formed laterally in said rail 2 and said sheath 30. The longitudinal axis of each hole is horizontal and the or each locking pin 32 occupies a horizontal position, perpendicular to the longitudinal axis of the rail 2. The or each locking pin 32 is fixed rigidly, by one of its extremities, to a vertical plate that the handle 41 possesses, this plate extending downwards from the handle. According to this arrangement, the locking of the head 3 in position along the rail 2 results from moving the chock 4 towards its locked position and introducing the or each locking pin into a hole of the sheath 30 and into a hole 20 of the rail. Preferably, the head has two locking pins.

The chock 4 has means of immobilization in rotation in the sheath 35. These means consist of a longitudinal guide 43 fixed to the chock 4 and extending over the outer surface of the latter along one of its generatrices, and a longitudinal groove 36 formed in the sheath 35, for slidably receiving the longitudinal guide 43.

According to the second form of embodiment of the device, the guide rail 2 is provided with a longitudinal guide 21, and the head 3 is equipped with anti-friction bearings 21a bearing on the longitudinal guide 21.

Advantageously, these anti-friction bearings 21a each have a groove and bear on the longitudinal guide 21 via the bottom of the groove. Such an arrangement, as well as facilitating the movement of the head 3 along the rail 2, has the effect of contributing to immobilizing the latter in rotation around the rail 2. It is noted that in this variant, the securing device is no longer equipped with the brace 36 and associated slide 36a.

Advantageously, the head 3 of the device according to this embodiment variant is equipped with a means of detecting the locked position of the chock 4, known per se.

Preferably, the head 3 of the device according to its two forms of embodiment is equipped with at least one additional locking pin 39 fixed to an electric actuator 39a, and the second sheath 35 and the chock 4 each have a radial hole. In the locked position of the chock 4, the radial hole borne by the chock is located in the axial alignment of the radial hole borne by the second sheath 35. By activating the actuator 39a, the locking pin 39 is brought into the alignment of holes thus formed and, in this locking position, maintains the chock 4 in the locked position. It goes without saying that any other means of locking could be used to maintain the chock 4 in the locked position. Thus, the electromagnet could act on a spur of the chock.

The device can also be equipped with a presence detector able to detect the presence of a vehicle by detecting the latter's wheel. This would be an infrared-type detector. A default signal will be emitted when there is no vehicle in the device. A default signal is also emitted when the chock is not in the locked position.

The dock installation according to the invention is equipped with at least one device according to the invention. The dock comprises a means of access, such as a door, that can occupy a first position, for example an open position, allowing goods to be transferred between the truck and a storage warehouse, the goods transportation vehicle, and a second position, for example a closed position not allowing this transfer. This installation comprises a position detector, known per se, able to detect at least the first position of the access means and emit an electrical signal in return. The installation comprises, in addition, a control unit able to activate the actuator 39a in the locking direction of the pin 39, based on the signal delivered by the position detector.

Thus, for a dock with a door, detection of the open condition of this door will result in the actuator being activated so that the pin 39 is brought into its locking position. The actuator 39a will be kept in its active condition while the door is detected to be open. Such an arrangement, by opposing the departure of the truck while the door remains open, increases safety.

Safety is also increased by the fact that the infrared detector of a vehicle's presence in the device and the detector of the locked position of the chock are connected electrically to the control unit, which can therefore, in the presence of the default signals emitted by these two detectors, keep the access means in its second position, i.e. for a door in a closed position.

It is clear that the present invention can receive any arrangements and variants of the field of technical equivalents without departing in any way from the framework of this patent, as defined by the claims below.

1/ Manual securing device, comprising a frame (1) forming a surface bearing on the ground, supporting above and away from this surface a horizontal rectilinear guide rail (2), on which is mounted slidably a support head (3) equipped with a chock (4) that can occupy a retracted position and a locked position away from the retracted position, characterized in that the rail (2) has a series of vertical cylindrical holes (20) regularly spaced along the horizontal sliding axis of the head (3), said head has a guide sheath (30) slidably engaged on the guide rail (2), said sheath (30) has at least one radial through-hole (31) designed to line up axially with one of the holes (20) of the guide rail (2) by sliding the head (3), and the head (3) has at least one movable locking pin (32) designed to be engaged in the alignment of holes (20, 31) formed, so that it can be immobilized in translation along the guide rail (2).

2/ Device according to claim 1, characterized in that the pin (32) is carried by an actuating lever (33) articulated to the head (3), above the guide rail (2).

3/ Device according to claim 2, characterized in that the locking pin (32) forms a protrusion under the lever (33).

4/ Device according to claim 1, characterized in that the head (3) has two locking pins (32) and the guide sheath (30) has two through-holes (31), separated from each other, designed to receive the two locking pins (32).

5/ Device according to claim 1, characterized in that the or each locking pin (32) is borne by the chock (4) and is engaged, in the locked position of the chock, in a hole of the sheath (30) and in a hole (20) of the rail (2).

6/ Device according to claim 1, characterized in that the chock (4) is formed of a horizontal rigid rod, slidably engaged in a second sheath (35) borne by the head (3) above the first sheath, the chock (4) and this second sheath (35) extending in a transverse direction with respect to that of the guide rail (2), and said chock (4) being able to take a retracted position, according to which it extends from one side of the guide rail, and a locked position, according to which it extends, by an active portion (40), from the other side of the guide rail, said active portion (40) being designed to come into contact with the tread surface of the corresponding wheel of the vehicle to be immobilized.

7/ Device according to claim 1, characterized in that the horizontal rail (2) has a circular straight cross-section and the head (3) is equipped with means of immobilization in rotation, these means being separate from the guide rail (2).

8/ Device according to claim 7, characterized in that one of the means of immobilizing the head (3) in rotation comprises a brace (36) fixed to the head (3) away from the longitudinal geometrical axis of the sheath (30), and a slider plate (11) borne by the frame, extending parallel to the guide rail (2), on which the brace (36) bears slidably by its lower extremity.

9/ Device according to claim 7, characterized in that the other means of immobilization in rotation comprises a first elongated stop (12) fixed to the frame (1) and extending parallel to the guide rail (2), and a second stop (38), fixed to the first sheath (30), this second stop (38) bearing slidably against the first stop (12).

10/ Device according to claim 1, characterized in that the chock (4) and the sheath (30) have an indexing means consisting of a spur (42) forming a radial protrusion on the cylindrical surface of the chock (4) and a notch (35a) made in the extremity of the sheath (30), designed to receive the spur (42) when the chock (4) is in the locked position.

11/ Device according to claim 2, characterized in that it has a means of detecting the locked position of the chock (4) and of detecting the locking position of the or each locking pin.

12/ Device according to claim 11 taken together, characterized in that the detection means consist of a first detection element fixed to a handle (41) that the chock (4) possesses, and a second detection element fixed to the actuating lever (33), the two detection elements coming opposite each other when the chock (4) is in the locked position and the or each locking pin is in the locking position in the corresponding hole(s) (20) of the guide rail.

13/ Device according to claim 1, characterized in that the head (3) is equipped with at least one additional locking pin (39) fixed to an electric actuator (39a), and the second sheath (35) and the chock (4) each have a radial hole, and in the locked position of the chock (4), the radial hole borne by the chock is located in the axial alignment of the radial hole borne by the second sheath (35), such that, by activating the actuator (39a), the locking pin (39) is brought into the alignment of holes thus formed and, in this locking position, maintains the chock (4) in the locked position.

14/ Loading dock installation, characterized in that it is equipped with a device according to claim 13.

15/ Installation according to claim 14, comprising a dock with a means of access that can occupy a first position, allowing goods to be transferred between a warehouse and the transport vehicle, and a second position, not allowing this transfer, characterized in that it comprises a control unit, able to activate the actuator (39a) in the locking direction of the pin (39), based on information delivered by a position detector associated to the access means, so as to prohibit the unlocking of the pin (39) while said access means is in its first position.

16/ Device according to claim 8, characterized in that the other means of immobilization in rotation comprises a first elongated stop (12) fixed to the frame (1) and extending parallel to the guide rail (2), and a second stop (38), fixed to the first sheath (30), this second stop (38) bearing slidably against the first stop (12).

17/ Device according to claim 1, characterized in that it has a means of detecting the locked position of the chock (4) and of detecting the locking position of the or each locking pin.
